(19) United States
(12) Patent Application Publication
(10) Pub. No.: US 2007/0129958 A1
(43) Pub. Date: Jun. 7, 2007

(54) Data sharing system and method

(75) Inventors: Benjamin Wu, San Jose, CA (US); Seongho Park, San Jose, CA (US)

Correspondence Address: BUCHANAN INGERSOLL & ROONEY PC, P.O. BOX 1404, ALEXANDRIA, VA, 22313-1404, US

(73) Assignee: Calyx Technology, Inc. d/b/a Calyx Software, San Jose, CA (US)

(21) Appl. No.: 11/607,536

(22) Filed: Dec. 1, 2006

Related U.S. Application Data
(60) Provisional application No. 60/748,574, filed on Dec. 7, 2005.

(51) Int. Cl. G06Q 99/00

(52) U.S. Cl. 705/1

(57) ABSTRACT

System and method for sharing data between a 3^{rd} party website and a desktop application program on a user's computer, wherein the web pages of the 3^{rd} party website access data associated with the application program such that the 3^{rd} party web pages drive the data exchange. The 3^{rd} party website is opened within a browser embedded within the desktop application program resident in a memory space on a user's computer and the web pages of the 3^{rd} party website are allowed access to the data associated with the desktop application. Restrictions may be placed on the access given to the 3^{rd} party web pages so that only data and information that is needed is accessed. The data associated with the desktop application may be stored in the memory space of the desktop application program, stored on the user's computer, or stored in a data source operably connected to the desktop application program.

### CROSS-REFERENCE TO RELATED APPLICATIONS

This application claims the benefit of co-pending provisional patent application Ser. No. 60/748,574 entitled “Dynamic Data Exchange Between an Internal Desktop Application and an External Trading Partner Website”, filed on Dec. 7, 2005, the entire disclosure of which is incorporated by reference herein.

### FIELD OF THE INVENTION

The present invention is directed toward a system and method for sharing data and, more particularly, toward a system and method for on-demand data exchange between a 3^{rd} party website and a desktop application.

### BACKGROUND OF THE INVENTION

Organizations typically run multiple internal software applications to operate various aspects of their businesses. Efforts to integrate these disparate software applications are generally considered to fall under the realm of Enterprise Application Integration (“EAI”).

With the advent of the World Wide Web (“web”), and the development of highly functional business-to-business websites, technicians performing EAI have been presented with a new set of integration challenges. For example, business-to-business websites are typically owned by external trading partners and are therefore generally outside the control of the organization seeking to integrate their internal software applications with the external trading partner website. This can lead to “islands to information” between organizations and their trading partners, resulting in data re-entry and data inconsistency between software applications internal to the organization and the external trading partner websites.

Various attempts have been made to address this situation, but past solutions have some limitations and problems.

One approach that has been used is to have the external website ask the user to submit files of data, as defined by the Internet Engineering Task Force in RFC 1867, “Form-based File Upload in HTML”. While this provides a mechanism for the website to pick up a data file, this is a manual process that involves the user, which presents some issues. First, the user must export a data file from the internal application, which itself may involve multiple steps and be prone to user error. Second, once the user has reached the file upload page of the external website, the user must locate and select the previously exported data file. This may involve browsing through multiple drives, directories, and files, which is a cumbersome and error-prone process. In particular, if the wrong file is selected, sensitive data may be sent to the external website, which may have serious security and privacy implications. Third, a reverse, and again manual, process must take place to bring data from the external website back into the internal application. The user must download a data file from the external website, then locate and select this data file for import in the internal application.

Another approach that has been used is for the external website to incorporate an ActiveX control to assist in the file upload process. While an ActiveX control may possibly alleviate some of the above problems associated with HTML file upload, this solution presents some additional issues. First, an ActiveX control is a full-fledged software program that gets executed on the user's computer. This poses a significant security risk to the organization, because such software may be intentionally malicious or unintentionally damaging to the files and settings associated with the user's computer. As a result, many organizations impose security policies blocking the download and use of ActiveX controls from external websites. Second, while an ActiveX control has extensive capabilities as a software program, it still may not have the technology and access rights needed to fully exchange data with the internal application.

Yet another approach that has been utilized is for the internal application to push data to the external trading partner website in a system-to-system interaction, separate from the user's interaction with the external website. While this solution bypasses the limitations of the website's ability to access local data, it presents some other issues. First, the data exchange is disjointed from the website's workflow. Business-to-business websites can have intricate, branching sequences of web pages for the user to work through, where particular exchanges of data are desired at particular points within the workflow. But because the internal application is pushing the data independent of the external website's workflow, the trading partner website must consume all potentially desirable data from the internal application before the need has been assessed. Furthermore, the trading partner must take additional steps to properly link the independently exchanged data with the user's actual session on the website. Second, the push of data necessitates a receiving server at the trading partner website. This may involve additional hardware, software, and/or code to specifically manage the data exchange, even though the trading partner simply wanted access to local data within the website. Third, this system-to-system push of data requires that a particular transmission protocol to be executed by the internal application to interact with a particular trading partner server. The trading partner may prefer to have full control over the transmission process and the destination of such transmission, with the ability to change that over time due to changing performance and security considerations. This exposure to, and dependence on, the internal application for transmission may not be desirable for the trading partner.

The present invention is directed toward overcoming one or more of the above-identified problems.

### SUMMARY OF THE INVENTION

The present invention includes a system and method for sharing data between a 3^{rd} party website and an application program on a user's computer. The inventive system and method permits web pages of the 3^{rd} party website to access data associated with the application program such that the 3^{rd} party web pages drive the data exchange.

In one form, the inventive method includes the steps. of opening a 3^{rd} party website in a browser embedded within a desktop application resident in a memory space on a user's computer, and allowing web pages of the 3^{rd} party website to access data associated with the desktop application. The web pages of the 3^{rd} party website are permitted to both read and write the data associated with the desktop application and, further, can read and write the data in real time. In one aspect, the web pages of the 3^{rd} party website drive the sharing of data, such that the web pages of the 3^{rd} party website control both the reading and writing of data associated with the desktop application.

A user can select and open the 3^{rd} party websites from a list of entries displayed in the desktop application. The access of the 3^{rd} party web pages to the data is controlled, however, to prevent the 3^{rd} party web pages from accessing other data on the user's computer, such that the 3^{rd} party web pages are permitted to access only that data that is needed by the 3^{rd} party web pages. The user may decide which data is accessible to the 3^{rd} party web pages.

In one aspect, each list entry of 3^{rd} party websites includes a profile associated with the particular 3^{rd} party website. The profile limits which web pages of the particular 3^{rd} party website are displayable in the desktop application and/or limits the data associated with the desktop application which is accessible to that particular 3^{rd} party website. The profiles are updatable by a vendor of the desktop application to either enhance or restrict the data accessible by a particular 3^{rd} party website.

A user may also be prompted to approve or deny access to data before the 3^{rd} party website is granted access to the data. This provides a further layer of protection in addition to the protection provided by the profiles.

In a further form of the inventive method, access to the data that is given to the 3^{rd} party website is limited to a particular data block resident in the memory space of the desktop application. In a further form, the data block includes a data file opened in the memory space of the desktop application. Thus, in this form, the 3^{rd} party website receives access only to data files, or blocks, opened on the user's computer.

In yet a further form of the inventive method, the web pages of the 3^{rd} party website not only select the data associated with the desktop application for reading and writing, but also select a format of the data associated with the desktop application for reading and writing. For example, the format selected for reading does not have to be the same format selected for writing. Typically, however, before the 3^{rd} party website can make any changes to the data, the user will be prompted to accept any such changes to maintain the integrity of the data.

The web pages of the 3^{rd} party website can also write its own unique identifier to the data, such that the unique identifier can be read by the web pages of the 3^{rd} party website during subsequent data accesses. This allows the 3^{rd} party web pages to be able to tell whether or not they have previously accessed the data. In one aspect, the unique identifier may be used by a vendor of the desktop application for billing purposes.

The data associated with the desktop application may be stored on the user's computer, or stored in a data source operably connected to the desktop application. The only requirement is that the data be accessible by the desktop application.

In still a further form of the inventive method, the 3^{rd} party website is allowed to store a 3^{rd} party specific document in the data associated with the desktop application. The 3^{rd} party website may also store a status indicator in the data associated with the desktop application, with the status indicator providing a status of services performed by the 3^{rd} party.

The inventive method finds particular utility in the area of mortgage loans where a loan originator assists a borrower in obtaining a loan. In this aspect, the desktop application may be a loan origination software program, the data associated with the desktop application may include mortgage loan data, and the 3^{rd} party websites may be websites of trading partners that are a party to the transaction, such as, but not limited to, lenders, investors and service providers.

As previously noted, the present invention also contemplates a system for sharing data between a 3^{rd} party website and an application program on a user's computer. In one form, the inventive system includes a desktop application resident in a memory space on a user's computer, and a web browser embedded within the desktop application. The desktop application includes a data proxy which couples data associated with the desktop application with the web pages of the 3^{rd} party website that is opened within the web browser, such that data associated with the desktop application is accessible by the 3^{rd} party web pages, via the data proxy. The web pages of the 3^{rd} party website are permitted to both read and write the data associated with the desktop application and, further, can read and write the data in real time. In one aspect, the web pages of the 3^{rd} party website drive the sharing of data, such that the web pages of the third party website control both the reading and writing of data associated with the desktop application.

In one aspect, the 3^{rd} party web pages include a client-side script which interfaces with the data proxy to access data. The data proxy responds to a request for data made by the client-side script and shares the data with the 3^{rd} party web pages.

A user can select and open the 3^{rd} party websites from a list of entries displayed in the desktop application. The access of the 3^{rd} party web pages to the data is controlled, however, by a data limiter provided between the 3^{rd} party web pages and the data proxy. The data limiter controls the access of the data associated with the desktop application by the 3^{rd} party web pages, such that the 3^{rd} party web pages are permitted to access only that data that is needed by the 3^{rd} party web pages. The user may decide which data is accessible to the 3^{rd} party web pages.

In a further form of the inventive system, the desktop application includes profiles associated one each with particular 3^{rd} party websites, such that each profile limits the web pages of the particular 3^{rd} party website displayable in the desktop application and/or limits, via the data limiter, the data associated with the desktop application accessible to the particular 3^{rd} party website. The profiles are updatable by a vendor of the desktop application to either enhance or restrict the data accessible by a 3^{rd} party website.

A user may also be prompted to approve or deny access to data before the 3^{rd} party website is granted access to the data. This provides a further layer of protection in addition to the protection provided by the profiles.

In still a further form of the inventive system, access to the data that is given to the 3^{rd} party website is limited, via the data limiter, to a particular data block resident in the memory space of the desktop application. In yet a further form, the data block includes a data file opened in the memory space of the desktop application. Thus, in this form, the 3^{rd} party website receives access only to data files, or blocks, opened on the user's computer.

The data associated with the desktop application may be stored on the user's computer, or stored in a data source operably connected to the desktop application. The only requirement is that the data be accessible by the desktop application.

In another form of the inventive system, the desktop application includes a deserializer which retrieves the data block from the data source operably connected to the desktop application and stores the data block in the memory space of the desktop application. The desktop application also includes a serializer which performs a reverse operation and retrieves the data block from the memory space of the desktop application and stores the data block back in the data source operably connected to the desktop application.

In yet a further form of the inventive system, the web pages of the 3^{rd} party website not only select the data associated with the desktop application for reading and writing, but also select a format of the data associated with the desktop application for reading and writing. For example, the format selected for reading does not have to be the same format selected for writing. Typically, however, before the 3^{rd} party website can make any changes to the data, the user will be prompted to accept any such changes to maintain the integrity of the data.

The web pages of the 3^{rd} party website can also write its own unique identifier to the data, such that the unique identifier can be read by the web pages of the 3^{rd} party website during subsequent data accesses. This allows the 3^{rd} party web pages to be able to tell whether or not they have previously accessed the data. In one aspect, the unique identifier may be used by a vendor of the desktop application for billing purposes.

In an additional form of the inventive system, the 3^{rd} party website is allowed to store a 3^{rd} party specific document in the data associated with the desktop application. The 3^{rd} party website may also store a status indicator in the data associated with the desktop application, with the status indicator providing a status of services performed by the 3^{rd} party.

The inventive system finds particular utility in the area of mortgage loans where a loan originator assists a borrower in obtaining a loan. In this aspect, the desktop application may be a loan origination software program, the data associated with the desktop application may include mortgage loan data, and the 3^{rd} party websites may be websites of trading partners that are a party to the transaction, such as, but not limited to, lenders, investors and service providers.

It is an object of the present invention to provide integrated data sharing between two applications that normally exist in isolation and require user intervention and/or additional software components to share data.

It is a further object of the present invention to provide data sharing between a desktop application and a 3^{rd} party website, such that the 3^{rd} party website “pulls” the data it needs from the desktop application on demand.

It is still a further object of the present invention to provide data sharing between a desktop application and a 3^{rd} party website where only select data is accessible to the 3^{rd} party website. In one form, this select data includes data associated with the desktop application that is relevant and appropriate to the transaction.

Other objects, aspects and advantages of the present invention can be obtained from a study of the specification, the drawings, and the appended claims.

### BRIEF DESCRIPTION OF THE DRAWINGS

FIG. 1 illustrates a data sharing system according to a first embodiment of the present invention;

FIG. 2 illustrates a data sharing system according to a second embodiment of the present invention; and

FIG. 3 is a flowchart illustrating the method steps in accordance with one embodiment of the present invention.

### DETAILED DESCRIPTION OF THE INVENTION

A system and method for sharing data is described herein. To facilitate such description, well-known structures and devices are shown generally in block diagram form. However, the description of the various embodiments provided herein is in no way meant to limit the scope of the appended claims.

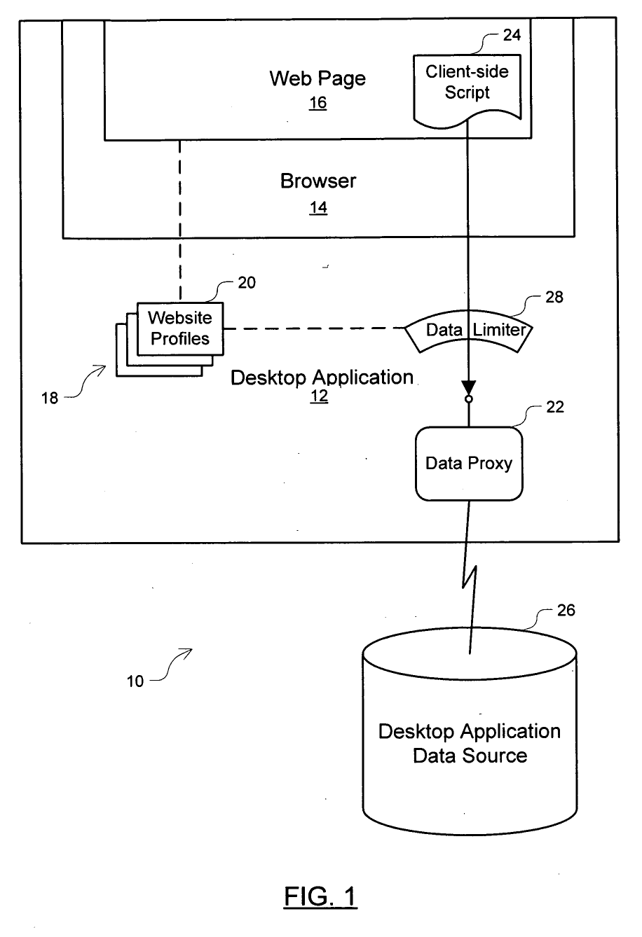

FIG. 1 illustrates a data sharing system according to a first embodiment of the present invention, shown generally at 10. The system 10 includes a desktop application 12 which is resident in a memory space on a user's computer. A web browser program 14 is embedded within the desktop application 12, and is integrated with the desktop application 12 as is known in the art. When a 3^{rd} party website is accessed, as will be described hereafter, the 3^{rd} party web page 16 is opened within the browser 14.

A user opens a 3^{rd} party web page by selecting a 3^{rd} party website from a list of entries 18 displayed in the desktop application 12. Typically, the list of entries 18 will be in the form of a drop down list which a user may click on to choose between various 3^{rd} party websites. Each list entry 18 includes a website profile 20 associated with a particular 3^{rd} party website. The profiles 20 include a set of rules which limit the web pages 16 of the particular 3^{rd} party website which are displayable in the desktop application 12, and/or limit the data associated with the desktop application 12, that is accessible to that particular 3^{rd} party website. The information included in the profiles 20 is also updatable by a vendor of the desktop application 12. Thus, different rules of access may be applied to different 3^{rd} party websites, via the profiles 20.

When the 3^{rd} party web page 16 is opened within the browser 14, data associated with the desktop application 12 is accessible by the 3^{rd} party web page 16 via a data proxy 22 further included within the desktop application 12. The 3^{rd} party web pages 16 will typically include a client-side script 24 interfacing with the data proxy 22. When the 3^{rd} party web page 16 is opened, the client-side script 24 can make a request for data from the data proxy 22. The data proxy 22 responds to the request for data made by the client-side script, and will retrieve the requested data from a data source 26. The data source 26 may be resident in the memory space of the desktop application 12; located outside the desktop application 12 but on the user's computer; or may be located remote from the user's computer and operably connected to the desktop application 12.

A data limiter 28 is provided between the 3^{rd} party web pages 16 (specifically, the client-side script 24) and the data proxy 22. The data limiter 28 controls the access of data associated with the desktop application 12 by the 3^{rd} party web pages 16. The data limiter 28 uses information from the profile 20 of the particular 3^{rd} party website selected by a user, and limits the data which may be accessed by the 3^{rd} party web pages 16 in accordance with the data restrictions provided in the website profile 20. Additionally, a user may also be prompted to approve or deny access to data before the 3^{rd} party website is granted access to the data. This provides a further layer of protection in addition to the protection provided by the profiles 20.

The web pages 16 of the 3^{rd} party website may read from and write to the data associated with the desktop application 12 which is accessible to the web pages 16. Moreover, the 3^{rd} party website controls the reading and writing of data by selecting which data it wants for reading and writing, albeit within the constraints of the website profiles 20. For example, while the profiles 20 may have given a particular 3^{rd} party website access to twenty-eight pieces of data, the 3^{rd} party website may only require fifteen of those pieces. When the web page 16 of the 3^{rd} party website is opened within the browser 14, a request for those fifteen data items is made by the client-side script 24 to the data proxy 22, via the data limiter 28, and only those fifteen pieces of data requested by the 3^{rd} party web page 16 will be retrieved. Thus, the 3^{rd} party website is not burdened with processing an abundant amount of data and then having to sift through the data to identify what it requires. The 3^{rd} party website can drive the data exchange and choose which data it wishes to access and only that data will be shared.

The web pages 16 of the 3^{rd} party website can also select a format of the data associated with the desktop application 12 for reading and writing. For instance, the data stored in the data source 26 may be in a format proprietary to the desktop application 12. When the client-side script 24 makes a request for data from the data proxy 22, it may request that the data be provided in, for example, an XML format. The data will be retrieved from the data source 26 and provided to the web page 16 formatted into XML. The 3^{rd} party web page 16 can also select a format of the data for writing, such that it may choose to write the data back to the data source 26 in, for example, comma-delimited format rather than XML format. The format selected for reading does not have to be the same format selected for writing. The 3^{rd} party web page 16 may also make other modifications to the data, as required, and store the modified data back in the data source 26. In this manner, the data reflected on the 3^{rd} party web page 16 and the data stored in the data source 26 may be synchronized. However, to prevent the 3^{rd} party web pages 16 from arbitrarily modifying data, typically, when modified data is to be stored back to the data source 26, the user will be prompted of the change and requested to accept the change.

Additionally, the web pages 16 of the 3^{rd} party website can write its own unique identifier to the data associated with the desktop application 12. This identifier may be read by the web pages 16 of the 3^{rd} party website during subsequent accesses and used by the web pages 16 to keep a record of the various actions that have been taken on that data. This unique identifier may also be used by a vendor of the desktop application 12 for billing purposes. The 3^{rd} party website may also be allowed to store a 3^{rd} party specific document in the data associated with the desktop application 12. Further, the 3^{rd} party website may also store a status indicator in the data associated with the desktop application 12, with the status indicator providing a status of services performed by the 3^{rd} party.

In the embodiment shown in FIG. 1, the desktop application 12 is basically acting as an agent for the 3^{rd} party web pages 16. Typically, web pages do not have access to anything locally on a computer; however, by opening the web pages 16 within the browser 14 embedded within the desktop application 12, the web pages 16 can essentially borrow rights and privileges from the desktop application 12 and utilize those rights and privileges to access data associated with the desktop application 12. Additionally, the 3^{rd} party web pages 16 can access functions of the desktop application 12. For example, the client-side script 24 may request from the data proxy 22 a list of every data file in an organization. The data proxy 22, assuming these rights are verified in the website profile 20, will provide the web pages 16 with a catalog of all data files. The web page 16 may further request, for example, a certain file within the catalog of files, or may request all files of a particular type. Thus, by allowing the web page 16 to borrow the rights and privileges of the desktop application 12, the web page 16 can control the data access and can access the data associated with the desktop application 12 in real time.

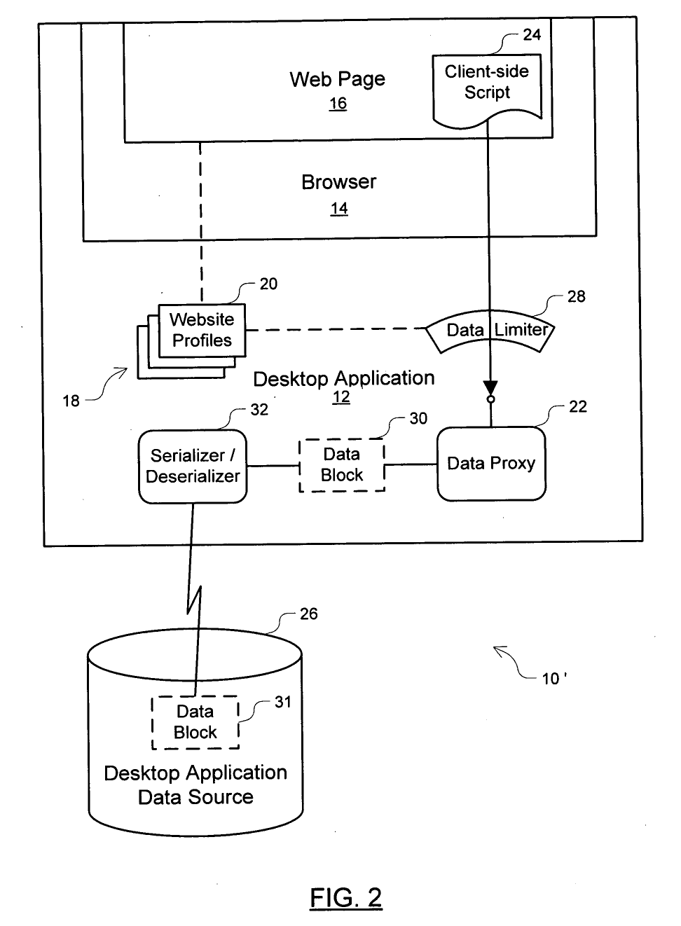

Referring to FIG. 2, a system for sharing data between a 3^{rd} party website and a desktop application 12 is shown according to a second embodiment of the present invention, generally at 10′. In FIG. 2, those elements of FIG. 1 are identified with the same reference number, and those elements that require modification are identified with a prime (′′′′′).

In FIG. 2, the data that is accessible by the 3^{rd} party web pages 16 includes only a data block 30 resident in the memory space of the desktop application 12. In one aspect of the invention, the data block 30 includes a data file which has been opened in the memory space of the desktop application 12. In this second embodiment, the desktop application 12 includes both a serializer and a deserializer, which are identified in FIG. 2 as one serializer/deserializer unit 32. The deserializer 32 retrieves the data block 31 from the data source 26, which is operably connected to the desktop application 12, and reconstitutes the data block 30 in the memory space of the desktop application 12. After the 3^{rd} party web pages 16 are finished accessing data in the data block 30, the serializer 32 retrieves the data block 30 from the memory space of the desktop application 12 and persists the data block 31 in the data source 26.

The embodiment of FIG. 2 is unique in that it allows both the web pages 16 and the desktop application 12 to work on the same data block 30 at the same time. Since the data block 30 is stored in the memory of the desktop application 12, changes made to the data block 30 by the web page 16 are immediately viewable by the desktop application 12, and changes made to the data block 30 by the desktop application 12 are immediately viewable by the web page 16. Every time the web page 16 wants to modify something in the data block 30, the user may be prompted. After the web page 16 and/or desktop application 12 are finished working on the data block 30, the user can decide whether he/she wishes to save the modified data block 30. The user can save the modified data block 30 by either overwriting the previous data block 31 in the data source 26, or storing the modified data block 30 as a new data block 31 in the data source 26.

Safeguards are built in, via the data proxy 22, to ensure that the web page 16 is not able to access any other data on the user's computer other than the data block 30 opened within the memory of the desktop application 12.

The inventive system and method have several distinguishing features, which are identified below.
The desktop application 12 is not required to have either: (a) a database or any other local or network data store; (b) ability to call web services provided by a 3^{rd} party website; or (c) a server to respond to incoming web services requests from a 3^{rd} party website.
The 3^{rd} party website is not required to have any of the following: (a) a database or any other local or network data store; (b) ability to call web services provided by a desktop application; or (c) a server to respond to incoming web services requests from an organization.
The 3^{rd} party web pages 16 are not required to have ActiveX controls, Java Applets or other additional software components.
Because the 3^{rd} party web pages 16 execute within the computer process of the desktop application 12, the 3^{rd} party web page 16 has real-time access into the in-memory data objects of the desktop application 12 as well as data sources accessible by the desktop application 12, as exposed through the data proxy 22. The web page 16 does not natively need to possess knowledge of how to locate data in the organization, or how to gain access to the data, or how to extract the data.
In one embodiment in FIG. 1, the desktop application 12 acts as an agent for the 3^{rd} party web pages 16 to provide access to data associated with the desktop application 12 that the web pages 16 would not otherwise have direct access to.
In another embodiment in FIG. 2, the desktop application 12 and web page 16 are able to collaboratively access the same data block 30 in the memory space of the desktop application 12.
This “pull architecture” enables the 3^{rd} party web page 16 to initiate and drive all data exchange, based on the particular needs and processes of the 3^{rd} party website. On demand, the 3^{rd} party web page 16 may choose to read from or write to the data associated with the desktop application 12. Furthermore, because the data exchange is driven through the client-side script 24, the data exchange may be invoked by the web page 16 at any time, either in response to some user action or without user intervention.
The data exchange takes place between the desktop application 12 and the 3^{rd} party web page 16, all executing in one memory space on one desktop machine without a server or transmission involved. The web page 16 can choose to process the data itself using the client-side script 24 without transmission to a server. Or, optionally, the web page 16 may transmit the data to a server for processing. The web page 16 determines the need for any transmission and executes such transmission according to its own protocol. The processing and/or transmission of data is handled by the web page 16, and can therefore be changed at any time, because the desktop application 12 does not take part in the transmission.
One net effect of the present invention is to allow the trading partner to operate their website as if it had direct access to two data sets, namely, the external data of the 3^{rd} party website and the internal data of the organization. Unlike other data exchange methods that may be one-directional or have no relation to user interface, the present invention enables the trading partner to address the user experience on their website in conjunction with the current data sets of both the 3^{rd} party website and the organization they are seeking to serve. The trading partner website workflow can be dynamically based on either data set. Furthermore, the trading partner website may choose to keep both data sets in sync, or deliberately allow discrepancies to exist between the two data sets.

The present invention, without limiting any aspect thereof, has particular utility in the mortgage loan industry. In such an application, the desktop application 12 is typically a loan origination software program that operates and is resident on a user's computer. The 3^{rd} party websites may be websites of trading partners that are a party to the transaction, such as, but not limited to, lenders, investors and service providers.

It is to be understood, however, that the present invention is not limited to loan origination software programs. Instead, the present invention may be used such that any application program can give access to 3^{rd} party websites such that the 3^{rd} party website can both read from, and write to, data stored in the memory of the desktop application, or stored on the user's computer, or stored in a database separate from the user's computer but operably connected thereto.

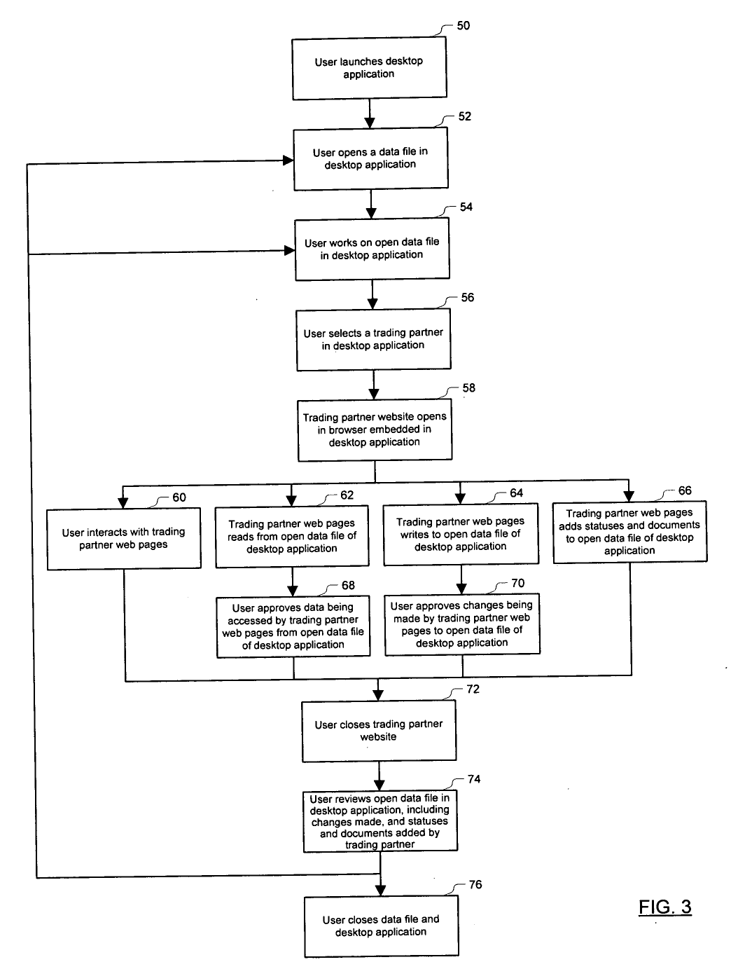

FIG. 3 is a flowchart illustrating the method steps in accordance with one embodiment of the present invention. As shown in FIG. 3, at step 50, the user launches the desktop application, which is resident in a memory space on the user's computer. The user then, at step 52, opens a data file in the desktop application. The user can work on the open data file in the desktop application, at step 54, making changes or other modifications to the data as desired. With the data file opened within the desktop application, the user selects, at step 56, a trading partner in the desktop application. Typically, the user selects a trading partner from a list of entries displayed in the desktop application, which can be provided in the form of a drop down list which the user may click on to choose between various trading partners.

After selection of the trading partner at step 56, the trading partner website opens in a web browser embedded within the desktop application, at step 58. The trading partner website will typically have access to only that data file which is opened within the desktop application; however, a user may also grant the trading partner website access to other data associated with the desktop application. The rights and privileges of the trading partner website are generally identified in profiles associated with each particular trading partner website. The profiles include a set of rules which limit the web pages of the particular trading partner website which are displayable in the desktop application and/or limit the data accessible by the trading partner web pages. After the trading partner website is opened in the embedded web browser, at step 58, any of the subsequent steps 60, 62, 64, 66, 68 and 70 may be performed individually or concurrently multiple times.

In one method flow, the user, at step 60, interacts with the trading partner web pages in a conventional manner.

In another method flow, the trading partner web pages, at step 62, can read data from the open data file in the desktop application. Typically, the trading partner web pages will drive the data exchange in a manner as previously described. The data in the open data file can be readily accessible to the trading partner web pages or, at step 68, the user can approve the data being accessed by the trading partner web pages from the data file opened in the desktop application. In step 68, the user may be provided with a prompt to click on to approve any data exchange with the trading partner web pages.

In a further method flow, the trading partner web pages, at step 64, can write to the open data file. In step 64, the trading partner web pages can add data, modify data, restructure data, etc., in the open data file. The user, at step 70, can approve any changes being made to the data in the open data file by the trading partner web pages. Again, the user may be provided with a prompt to click on to approve any data write by the trading partner web pages.

In yet a further method flow, the trading partner web pages, at step 66, may add statuses, identifiers and/or documents to the open data file. These statuses, identifiers and/or documents may be used later by the trading partner web pages in subsequent accesses for a variety of purposes.

Steps 60, 62, 64, 66, 68 and 70 and the resulting method flows may be performed in any order, individually or concurrently, and also may be performed multiple times while the trading partner website is opened within the embedded web browser in the desktop application.

When the user is finished sharing data with the trading partner web pages, the user closes the trading partner website, at step 72. The user can then review the open data file in the desktop application, including any changes, additions, modifications, etc., made by the trading partner web pages that were previously accepted by the user, at step 74. The user may decide to accept or reject these changes at this time, which provides the user with an additional layer of protection for the data shared with the trading partner website. The user can accept the changes by writing over the original stored data file, or may save the modifications as a new data file if the original stored data file is to be maintained.

The method of the present invention can then refer back to either step 52 or 54. If the user desires to open a new data file, the method reverts back to step 52 where the user opens a new data file in the desktop application, and the inventive method continues from there. Alternately, the user can decide to continue working on the open data file, possibly in its modified form, and the method reverts back to step 54, and the inventive method continues from there. The inventive method ends at step 76 when the user closes the data file and the desktop application.

An advantage of the present invention is that the user is not required to perform a particular action, such as import and export, to share data with the trading partner. Rather, simply by opening up the trading partner's web page within the desktop application, the data currently open in the desktop application becomes available to the trading partner's web pages. As such, the user simply selects a trading partner, and the trading partner then drives the data exchange, without requiring user intervention. Because the user does not select files for import and export, user error is eliminated with regard to what data gets shared with the trading partner. The trading partner's access to data is automatically limited to the data currently open in the desktop application.

Another advantage of the present invention is that the trading partner's access to data is further limited by the website profile. In addition, the user may choose to accept or deny each data access attempted by the trading partner.

A further advantage of the present invention is that the trading partner website “pulls” the data it needs from the desktop application on demand, rather than the desktop application “pushing” all potentially desirable data to the trading partner website upfront. As part of the trading partner website workflow with the user, individual web pages may read and/or write the portions of data needed, in the format needed, at the time needed. The trading partner website is not burdened with the processing and/or storage of data in advance of the time of need, or exceeding the scope of need. In addition, because the trading partner website can write just the portions of data it intends to modify, it is not burdened with storing and/or repeating back the portions of data that have not been modified.

Because the trading partner web page drives the data exchange, an advantage is that when a user changes data on a trading partner's web page, the trading partner's web page can optionally simultaneously change the opened data file in the user's desktop application for consistency.

An additional advantage of the present invention is that the trading partner can implement new data exchange workflows without requiring any modification in the desktop application program. This is due to the fact that the trading partner web pages drive the data exchange functions. The trading partner may update their web pages at any time to utilize different data exchange functions, or utilize the functions in a different manner, or in a different order, or on different web pages. Furthermore, because the desktop application program does not participate in any transmission of data, the trading partner can choose to involve different servers at any time to process the data being exchanged in a fundamentally different manner.

Since the trading partner's web page can store its own identifier in the data file, an advantage is that context can be preserved in subsequent website visits from within the same data file. By retrieving its own identifier from the data file of the desktop application, the trading partner website can seamlessly render its web pages according to the user's past interactions with the website on the same data file.

Another advantage of the present invention is that the trading partner can store its own 3^{rd} party specific documents and status indicators in the data file of the desktop application, utilizing the data file as an extensible repository.

While the present invention has been described with particular reference to the drawings, it should be understood that various modifications could be made without departing from the spirit and scope of the present invention.

The following set of claims is not limiting, but is merely exemplary of preferred aspects of the present invention. Thus, the following claim set has been included only to facilitate understanding of the present invention. It is to be understood that the present patent application instead covers all aspects of the present invention as shown and described herein. The present invention is thus not limited to the invention as described in the following claims.

We claim:

1. A data sharing method comprising the steps of:
opening a 3^{rd} party website in a browser embedded within a desktop application resident in a memory space on a user's computer; and
allowing web pages of the 3^{rd} party website to access data associated with the desktop application.

2. The method of claim 1, wherein the web pages of the 3^{rd} party website read and write the data associated with the desktop application.

3. The method of claim 2, wherein the web pages of the 3^{rd} party website drive the data sharing, such that the web pages of the 3^{rd} party website control both the reading and writing of data associated with the desktop application.

4. The method of claim 1, wherein the user selects and opens the 3^{rd} party website from a list of entries displayed in the desktop application.

5. The method of claim 4, wherein each list entry includes a profile associated with a particular 3^{rd} party website, and wherein the profile: (a) limits the web pages of the particular 3^{rd} party website displayable in the desktop application; and/or (b) limits the data associated with the desktop application accessible to the particular 3^{rd} party website.

6. The method of claim 5, wherein information included in the profiles is updatable by a vendor of the desktop application.

7. The method of claim 1, wherein a user decides which data is accessible to the 3rd party website.

8. The method of claim 1, wherein the web pages of the 3^{rd} party website select the data associated with the desktop application for reading and writing.

9. The method of claim 1, wherein the web pages of the 3^{rd} party website select a format of the data associated with the desktop application for reading and writing.

10. The method of claim 1, wherein the web pages of the 3^{rd} party website write its own unique identifier to the data associated with the desktop application.

11. The method of claim 10, wherein the unique identifier is read by the web pages of the 3^{rd} party website during subsequent data accesses.

12. The method of claim 10, wherein the unique identifier is used by a vendor of the desktop application for billing purposes.

13. The method of claim 1, wherein the desktop application allows the 3^{rd} party web pages to access the data associated with the desktop application in real time.

14. The method of claim 1, wherein the data associated with the desktop application accessible by the 3^{rd} party web pages includes only a data block resident in the memory space of the desktop application.

15. The method of claim 14, wherein the data block comprises a data file opened in the memory space of the desktop application.

16. The method of claim 1 wherein the data associated with the desktop application is stored in a data source operably connected to the desktop application.

17. The method of claim 1, further comprising the step of allowing the 3^{rd} party website to store a 3^{rd} party specific document in the data associated with the desktop application.

18. The method of claim 1, allowing the 3^{rd} party website to store a status indicator in the data associated with the desktop application, wherein the status indicator provides a status of services performed by the 3^{rd} party.

19. The method of claim 1, wherein the desktop application is a loan origination software program.

20. The method of claim 1, wherein the data comprises mortgage loan data.

21. A data sharing system comprising:
a desktop application resident in a memory space on a user's computer; and
a web browser embedded within the desktop application;
wherein the desktop application includes a data proxy coupling data associated with the desktop application with the web pages of a 3^{rd} party website opened within the web browser, and
wherein data associated with the desktop application is accessible by the 3^{rd} party web pages via the data proxy.

22. The data sharing system of claim 21, wherein the web pages of the 3^{rd} party website read and write the data associated with the desktop application.

23. The data sharing system of claim 22, wherein the web pages of the 3^{rd} party website drive the data sharing, such that the web pages of the 3^{rd} party website control both the reading and writing of data associated with the desktop application.

24. The data sharing system of claim 21, wherein the user selects and opens the 3^{rd} party website from a list of entries displayed in the desktop application.

25. The data sharing system of claim 21, wherein the desktop application further includes a data limiter provided between the 3^{rd} party web pages and the data proxy, wherein the data limiter controls access of the data associated with the desktop application by the 3^{rd} party web pages.

26. The data sharing system of claim 25, wherein the desktop application includes profiles associated one each with particular 3rd party websites, wherein each profile: (a) limits the web pages of the particular 3^{rd} party website displayable in the desktop application; and/or (b) limits, via the data limiter, the data associated with the desktop application accessible to the particular 3^{rd} party website.

27. The data sharing system of claim 26, wherein information included in the profiles is updatable by a vendor of the desktop application.

28. The data sharing system of claim 21, wherein a user decides which data is accessible to the 3rd party website.

29. The data sharing system of claim 21, wherein the web pages of the 3^{rd} party website select the data associated with the desktop application for reading and writing.

30. The data sharing system of claim 21, wherein the web pages of the 3^{rd} party website select a format of the data associated with the desktop application for reading and writing.

31. The data sharing system of claim 21, wherein the web pages of the 3^{rd} party website write its own unique identifier to the data associated with the desktop application.

32. The data sharing system of claim 31, wherein the unique identifier is read by the web pages of the 3^{rd} party website during subsequent data accesses.

33. The data sharing system of claim 31, wherein the unique identifier is used by a vendor of the desktop application for billing purposes.

34. The data sharing system of claim 21, wherein the desktop application allows the 3^{rd} party web pages to access the data associated with the desktop application in real time.

35. The data sharing system of claim 21, wherein the data associated with the desktop application accessible by the 3^{rd} party web pages includes only a data block resident in the memory space of the desktop application.

36. The data sharing system of claim 35, wherein the data block comprises a data file opened in the memory space of the desktop application.

37. The data sharing system of claim 35, wherein the desktop application further includes a data limiter provided between the 3^{rd} party web pages and the data proxy, wherein the data limiter limits access of the 3^{rd} party web pages to only data stored in the data block.

38. The data sharing system of claim 35, wherein the desktop application includes a deserializer retrieving the data block from a data source operably connected to the desktop application and storing the data block in the memory space of the desktop application.

39. The data sharing system of claim 35, wherein the desktop application includes a serializer retrieving the data block from the memory space of the desktop application and storing the data block in a data source operably connected to the desktop application.

40. The data sharing system of claim 21, wherein the data associated with the desktop application is stored in a data source operably connected to the desktop application.

41. The data sharing system of claim 21, wherein the 3^{rd} party web pages include a client-side script interfacing with the data proxy, wherein the data proxy responds to a request for data made by the client-side script.

42. The data sharing system of claim 21, wherein the web pages of the 3^{rd} party website store a 3^{rd} party specific document in the data associated with the desktop application.

43. The data sharing system of claim 21, wherein the web pages of the 3^{rd} party website store a status indicator in the data associated with the desktop application, wherein the status indicator provides a status of services performed by the 3^{rd} party.

44. The data sharing system of claim 21, wherein the desktop application is a loan origination software program.

45. The data sharing system of claim 21, wherein the data comprises mortgage loan data.
